(19) United States
(12) Patent Application Publication
(10) Pub. No.: US 2003/0113608 A1
(43) Pub. Date: Jun. 19, 2003

(54) Gas-distributing plate for compact fuel cells and separator plate using the gas-distributing plate

(75) Inventors: Seong-Ahn Hong, Seoul (KR); In-Hwan Oh, Seoul (KR); Tae Hoon Lim, Seoul (KR); Suk Woo Nam, Seoul (KR); Heung Yong Ha, Seoul (KR); Sung Pil Yoon, Seoul (KR); Jong Hee Han, Seoul (KR); Yeong Cheon Kim, Seoul (KR); Hyung Joon Choi, Kyunggi-do (KR)

Correspondence Address: BROWDY AND NEIMARK, P.L.L.C., 624 NINTH STREET, NW, SUITE 300, WASHINGTON, DC, 20001-5303, US

(73) Assignee: Korea Institute of Science and Technology, Seoul (KR)

(21) Appl. No.: 10/283,121

(22) Filed: Oct. 30, 2002

(30) Foreign Application Priority Data
Dec. 17, 2001 (KR) 2001-0080124

(51) Int. Cl. H01M 8/04

(52) U.S. Cl. 429/34; 429/38; 429/39

(57) ABSTRACT

A perforated gas-distributing plate for compact fuel cells made of a metal material such as stainless steel on which gas flow paths are formed by an etching process, and a separator plate manufactured using the gas-distributing plate are disclosed.

The separator plate manufactured using the gas-distributing plate may possibly be thinner and no more susceptible to breakage by an externally applied force due to its higher physical strength, compared to conventional graphite separator plates. In addition, since the gas channels formed on the gas-distributing plate have the same dimension, contact resistance decreases and thus the performance of fuel cell increases. Furthermore, since the separator plate is made of a metal material such as stainless steel, cost and manpower are reduced when etching the separator plate, and thus mass production of the separator plate is possible. Therefore, compact fuel cells comprising the separator plate are advantageous in terms of power density, reliability and economic efficiency.

### BACKGROUND OF THE INVENTION

1. Field of the Invention

The present invention relates to a gas-distributing plate for compact fuel cells and a separator plate using the gas-distributing plate, and more particularly to a perforated gas-distributing plate for compact fuel cells made of a metal material such as stainless steel on which gas flow paths are formed by an etching process, and a separator plate manufactured using the gas-distributing plate.

2. Description of the Related Art

A compact fuel cell is used as a nonpolluting power source of compact portable electronic equipments such as cell phones, radio devices, notebook computers, etc. The compact fuel cell can replace conventional batteries requiring frequent charging and is useful especially when used in the open air. In order to develop the compact fuel cell having these advantages, many studies have been carried out for some years. The compact fuel cell commonly uses hydrogen or methanol as a fuel. Once the fuel is provided, the compact fuel cell directly generates electric power. Further, so long as the fuel can be provided, the fuel cell can continuously generate electric power. Accordingly, the compact fuel cell can replace batteries taking long in charging, and can charge conventional batteries without any power supply. Particularly, since hydrogen can be obtained from portable fuels such as LPG, gasoline, diesel, etc., by a reformer, it is possible to construct portable fuel cells using general fuels.

Most of portable compact fuel cells developed so far use a polymer electrolyte membrane, or a solid electrolyte such as a solid oxide membrane. In some cases, a liquid electrolyte such as alkaline aqueous solution, molten carbonate, etc., is used. The separator plate referred in the present invention is useable for all compact fuel cells using the solid and liquid electrolyte. Since the perforated gas-distributing plate for compact fuel cells and the separator plate using the gas-distributing plate according to the present invention may operate at relatively low temperatures and have high power density and relatively simple arrangement, they are applicable for a polymer electrolyte fuel cell.

The polymer electrolyte fuel cell mainly comprises a polymer electrolyte membrane, an anode layer and a cathode layer coated on both sides of the polymer electrolyte membrane, respectively, and a separator plate supplying the electrode layers with fuel and air. The electrolyte membrane coated with the electrode layers is called as a “membrane-electrode assembly (hereinafter, referred to as “MEA”)”. In the anode of MEA, hydrogen or methanol is converted into hydrogen ions (H⁺). The converted hydrogen ions migrate across the electrolyte membrane to the cathode, and react with oxygen in the cathode to produce water. At this step, electrons formed in the anode are delivered to the cathode via an external circuit so as to generate electricity. That is, the polymer electrolyte fuel cell converts chemical energy of hydrogen and oxygen into electrical energy. Further, the polymer electrolyte fuel cell can operate even at room temperature so that it is suitable for portable fuel cells.

The most commonly used polymer electrolyte fuel cell is constructed as successively laminated layers of a plurality of MEAs and separator plates. The separator plates provide each laminated MEAs with hydrogen and air, and play a role of connecting MEAs serially.

As a material of separator plate for the polymer electrolyte fuel cell, graphite is widely used in terms of its electric conductivity, weight, corrosion resistance, etc. A graphite separator plate is manufactured by shaping a graphite powder into a plate at high temperatures and high pressures, immersing the plate in a resin to obtain a graphite plate having a thickness of not less than 2 mm, and machining both sides of the graphite plate to form gas channels thereon. This method, however, has drawbacks that machining cost is high, machining time is long, and machining process is hard due to low mechanical strength of the graphite plate when the thickness of the plate is no greater than 3 mm.

Recently, trials to lower the machining cost and reduce the thickness of the graphite plate have been performed, for example, by pressing a fiber-reinforced graphite foil having a thickness of 1˜2 mm and forming flow paths thereon. However, the graphite separator plate thus manufactured also is not durable due to its brittleness and thus easily broken by an externally applied force. Therefore, there is a limitation in reducing the thickness of the graphite separator plate, which prevents the polymer electrolyte fuel cell from being practically used.

In order to solve these problems, some methods for manufacturing the separator plate using a metal have been suggested. The use of metal as a material of the separator plate can lower machining cost and reduce the thickness of the separator plate in a simple manner. U.S. Pat. Nos. 5,482,792(1996) and 5,798,187(1998) disclose methods for manufacturing a separator plate by bonding a perforated metal or a metal mesh capable of penetrating gases into the pores as a collector and a gas channel, to a thin metal plate. They also describe that the methods can lower machining cost and reduce the thickness of the separator plate. However, these methods have problems that the non-uniformity of the perforated metal and metal mesh surface increases the internal resistance in the contact faces of the MEA and the perforated metal or metal mesh, thus deteriorating the performance of the fuel cell.

For practical use of the polymer electrolyte fuel cell, the machining cost must be lowered and the thickness of the separator plate must be reduced in order to increase the power density per unit volume. In particular, in the case of portable compact fuel cell, the power density per unit volume can be improved by reducing the weight of the separator plate accounting for the weight of fuel cell.

### SUMMARY OF THE INVENTION

Therefore, the present invention has been made in view of the above-mentioned problems, and it is an object of the present invention to provide a gas-distributing plate for compact fuel cells made of a metal material such as stainless steel on which gas flow paths are formed by an etching process. The gas-distributing plate increases the performance of the fuel cells by increasing the contact area between an MEA and a separator plate, reduces the thickness of the gas-distributing plate while maintaining physical strength, and lowers machining cost.

It is another object of the present invention to provide a separator plate using the gas-distributing plate.

In accordance with the present invention, the above and other objects can be accomplished by the provision of a perforated gas-distributing plate for compact fuel cells, comprising a plate-shaped member made of metal and having a plurality of apertures, each of which has a diameter of no greater than 2 mm, wherein the plate-shaped member further has one face which is smooth and the other face which is formed with a plurality of gas channels by an etching process such that the channels are spaced apart one from another by a distance of no greater than 2 mm and each channel has a depth of no greater than 0.6 mm and a width of no greater than 2 mm.

The gas-distributing plate for compact fuel cells according to the present invention may be manufactured by forming a plurality of apertures on a metal plate by a pressing process to obtain a perforated metal plate, and then etching one face of the perforated metal plate to form fine gas channels on the face.

In accordance with one aspect of the present invention, the above and other objects can be accomplished by the provision of a separator plate for compact fuel cells comprising two perforated gas-distributing plates and a thin metal plate interposed between the two perforated gas-distributing plates, wherein the thin metal plate has a thickness of no greater than 0.6 mm and is sandwiched with each gas channel-formed face of the two perforated gas-distributing plates, and the two perforated gas-distributing plates and the thin metal plate are bonded to each other so as to ensure gas sealing.

One possible modification of the separator plate for compact fuel cells according to the present invention further comprises a metallic cooling fluid-distributing plate for defining a cooling fluid flow, wherein the two perforated gas-distributing plates, the thin metal plate and the metallic cooling fluid-distributing plate are bonded to one another so as to ensure gas sealing.

In accordance with the present invention, the perforated gas-distributing plate for compact fuel cells may be manufactured by forming apertures and gas channels in an etching process, simultaneously. Alternatively, the perforated gas-distributing plate according to the present invention may be manufactured by pressing the metal plate to form apertures therein, before etching the punched metal plate to form gas channels thereon.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is an exploded view of a separator plate for compact fuel cells according to the present invention;

FIG. 2 is a perspective view of a perforated gas-distributing plate for compact fuel cells according to the present invention; and

FIG. 3 graphically depicts the current-voltage relationship that exhibits performance of a compact fuel cell stack using a separator plate according to the present invention.

### DESCRIPTION OF THE PREFERRED EMBODIMENT

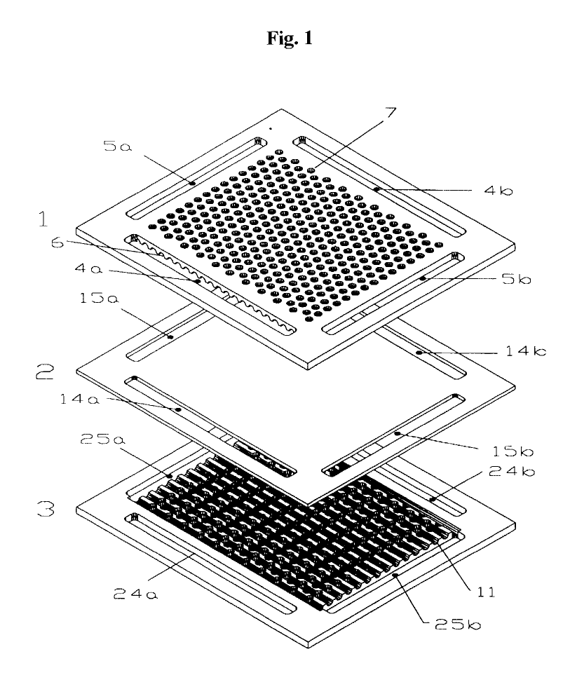

FIG. 1 is an exploded view of the separator plate for compact fuel cells according to the present invention. As shown in FIG. 1, the separator plate for compact fuel cells according to the present invention comprises a center plate 2 and two gas-distributing plates 1 and 3. The center plate having a thickness of no greater than 0.6 mm has manifolds 14a, 14b, 15a and 15b for defining the reactant flow. Fuel flows through manifolds 14a and 14b and air flows through manifolds 15a and 15b. The location of the manifolds can be changed with each other. The separator plate comprises two gas-distributing plates arranged on the upper and lower sides of the center of the center plate 2. The respective gas-distributing plate has a plurality of apertures passing through the plate and gas channels. The shape and size of gas channels and apertures may be identical or different from each other, depending on the condition of fuel cells. As shown in FIG. 1, the center plate 2 is interposed between gas channel-formed faces of the two perforated gas-distributing plates 1 and 3, and is bonded to two perforated gas-distributing plates 1 and 3 by a welding or the like so as to ensure gas sealing.

Gas flow in the gas-distributing plate 1 is as follows: gas introduced from a manifold 4a flows toward a manifold 4b through a gas channel 6. Subsequently, gas flows up the gas-distributing plate 1 through an aperture 7 so that gas is provided to an electrode, which is arranged at the top of the gas-distributing plate 1. Likewise, such a gas flow is applied in the gas-distributing plate 3. Thus 3 thin plates are fabricated and bonded to construct 1 separator plate.

According to the present invention, since the gas-distributing plate 1 is made of stainless steel, it is possible to reduce the thickness of the plate to 0.3˜0.6 mm. When two gas-distributing plates 1 and 3 are bonded with the center plate 2 having a thickness of about 0.3 mm, the separator plate of the present invention is considerably thinner (≦1.5 mm), compared to conventional graphite separator plates (about 3 mm). As well, the thickness reduction of the gas-distributing plates 1 and 3 results in considerably reducing the total weight of the separator plate.

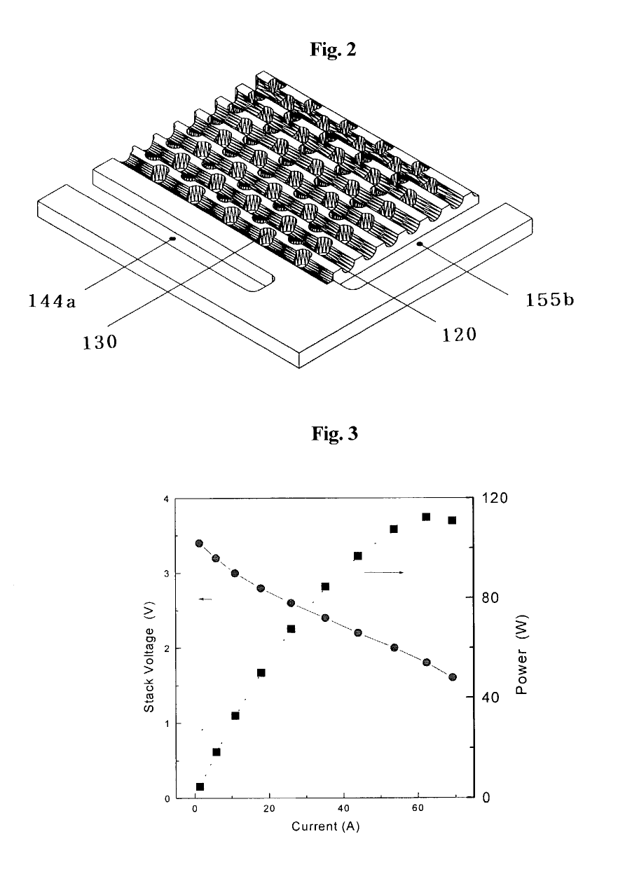

FIG. 2 is a perspective view of a perforated gas-distributing plate for compact fuel cells according to the present invention. As shown in FIG. 2, manifolds 144a and 155b are machined on a thin plate having a thickness of about 0.6 mm so that the location and shape is the same as those of the manifolds of the center plate 2. Gas channel 120 is fabricated on the thin plate for defining a gas flow. Aperture 130 is formed on a gas channel 120 at a predetermined interval so that gas passes through the plate.

In the case where the separator plate according to the present invention is made of stainless steel, corrosion may occur on the surface of the separator plate when the operation time of fuel cell is over thousands of hours. Accordingly, in order to protect the surface, corrosion resistant materials such as titanium alloys, etc., can be used in place of stainless steel. Stainless steel coated on the surface with gold or titanium nitride (TiN) can also be used.

Hereinafter, the present invention will now be described in more detail with reference to the following Examples and Preparative Examples. However, these examples are given by way of illustration and not of limitation.

### EXAMPLE 1

### Manufacture of Gas-Distributing Plate

As shown in FIG. 2, channels and apertures were formed on one face of a stainless steel plate (10 cm×10 cm) by an etching process. Before etching, a mask was adhered on one face of the plate so as to form apertures passing through the plate, and another mask was adhered on the other face of the plate so as to form gas channels and apertures. During etching, unmasked areas of the plate were eroded to manufacture a gas-distributing plate on which gas channels were formed. At this time, the diameter of the formed apertures was 2 mm, and the distance between the centers of apertures was 3 mm. As shown in FIG. 1, the formed apertures were arranged in a zigzag pattern. The formed gas channels had a dimension of 1.5 mm wide and 0.3 mm deep, and passed through the zigzagged apertures.

### EXAMPLE 2

### Manufacture of Gas-Distributing Plate

Apertures (diameter: 2 mm) were formed on a nickel plate (10 cm×10 cm) having a thickness of 0.7 mm by a pressing process. Then, one face of the plate was etched to form fine gas channels thereon. At this time, the width and depth of the gas channels were 1 mm and 0.4 mm, respectively. As shown in FIG. 2, the gas channels passed through the zigzagged apertures.

### PREPARATIVE EXAMPLE 1

### Preparation of Separator Plate for Compact Fuel Cells

A stainless steel plate (0.1 mm thick) was cut to the same size as the gas-distributing plate manufactured in Example 1 to manufacture a center plate. As shown in FIG. 1, the center plate was sandwiched with each gas channel-formed face of the two perforated gas-distributing plates manufactured in Example 1, and then bonded thereto by micro-TIG welding their edges to prepare a separator plate.

### PREPARATIVE EXAMPLE 2

### Preparation Of Fuel Cell Stack

1. Manufacture of MEA

Pt/C catalyst were mixed with Teflon solution in the presence of isobutyl alcohol, dried and heat-treated to obtain a 10 wt % Teflon-added catalyst for fuel cells. The catalyst for fuel cells was mixed with Nafion 115 solution in the presence of isobutyl alcohol and dispersed. The dispersion was coated on a carbon paper (Toray) to produce an electrode having a density of 0.7 mg Pt/cm². The electrode was arranged on both sides of Nafion 115 polymer membrane (DuPont), and hot-pressed using a press to manufacture an MEA. The area of the MEA thus manufactured was 100 cm² (10 cm×10 cm), and the area of electrode was 58 cm² (7.6 cm×7.6 cm).

2. Manufacture of Fuel Cell Stack

Fuel cell stack including 4 unit cells was manufactured by laminating the separator plates manufactured in Example 2 and the MEAs manufactured in Preparative Example 2-1. Current-voltage property of the fuel cell stack was determined at 75° C. under 1 atm. The result is shown in FIG. 3. Oxidizing agent and fuel used herein were oxygen and hydrogen, respectively. As can be seen from the FIG. 3, though the thickness of the separator plate has been reduced to 1.3 mm, there is no difference in performance between the fuel cell stack and conventional stacks using graphite separator plate. Further, the performance of the fuel cell according to the present invention is far superior to that of fuel cells using metal mesh.

In the gas-distributing plate for compact fuel cells according to the present invention, the gas channels and apertures can be variously formed depending on gas flow manners.

The separator plate according to the present invention has a thickness of no greater than 1.5 mm; whereas the thickness of conventional graphite separator plate is not less than 3 mm. In addition, the separator plate with less weight can be manufactured by selecting appropriate materials and machining methods, compared to conventional graphite separator plates. Further, since contact faces between electrodes and separator plates are more uniform, compared to perforated metal and metal mesh, it is expected that contact resistance decreases and thus the performance of the fuel cell increases.

A plurality of separator plates (10 cm×10 cm) including the perforated gas-distributing plate in which the aperture has a diameter of no greater than 2 mm, and the gas channel has a depth of no greater than 0.3 mm and a width of no greater than 1 mm can be manufactured from a sheet of stainless steel (1 m×2 m). Further, since the gas channel of the gas-distributing plate according to the present invention has a depth of no greater than 0.6 mm and a width of no greater than 2 mm, the time required for etching is short. Therefore, such a short etching time enables the perforated gas-distributing plate for fuel cells to be manufactured in large quantities.

As described above, the separator plate using the gas-distributing plate according to the present invention may possibly be thinner, and no more susceptible to breakage by an externally applied force due to its higher physical strength, compared to conventional graphite separator plates. In addition, since the gas channels formed on the gas-distributing plate according to the present invention have the same dimension, contact resistance in the contact faces of the MEA decreases and thus the performance of fuel cell increases. Furthermore, since the separator plate according to the present invention is made of a metal material such as stainless steel, cost and manpower are reduced when etching the separator plate, and thus mass production of the separator plate is possible. Therefore, compact fuel cells comprising the separator plate according to the present invention are advantageous in terms of power density, reliability and economic efficiency.

What is claimed is:

1. A perforated gas-distributing plate for compact fuel cells, comprising a plate-shaped member made of metal and having a plurality of apertures, each of which has a diameter of no greater than 2 mm,
wherein the plate-shaped member further has one face which is smooth and the other face which is formed with a plurality of gas channels by an etching process such that the channels are spaced apart one from another by a distance of no greater than 2 mm and each channel has a depth of no greater than 0.6 mm and a width of no greater than 2 mm.

2. The perforated gas-distributing plate as set forth in claim 1, wherein the gas-distributing plate is manufactured by forming a plurality of apertures on a metal plate by a pressing process to obtain a perforated metal plate, and etching one face of the perforated metal plate to form fine gas channels on the face.

3. A separator plate for compact fuel cells comprising two perforated gas-distributing plates as set forth in claim 1 and a thin metal plate interposed between the two perforated gas-distributing plates,
wherein the thin metal plate has a thickness of no greater than 0.6 mm and is sandwiched with each gas channel-formed face of the two perforated gas-distributing plates, and the two perforated gas-distributing plates and the thin metal plate are bonded to each other so as to ensure gas sealing.

4. The separator plate for compact fuel cells as set forth in claim 3 further comprising a metallic cooling fluid-distributing plate for defining a cooling fluid flow, wherein the two perforated gas-distributing plates, the thin metal plate and the metallic cooling fluid-distributing plate are bonded to one another so as to ensure gas sealing.
